(19) United States
(12) Patent Application Publication
(10) Pub. No.: US 2021/0372885 A1
(43) Pub. Date: Dec. 2, 2021

(54) ACOUSTIC BRIDGE

(71) Applicant: ZF FRIEDRICHSHAFEN AG, Friedrichshafen (DE)

(72) Inventors: Georg Tenckhoff, Friedrichshafen (DE); Michael Gierling, Langenargen (DE)

(21) Appl. No.: 16/339,725

(22) PCT Filed: Sep. 21, 2017
(86) PCT No.: PCT/EP2017/073920

§ 371 Date: Apr. 5, 2019

(30) Foreign Application Priority Data
Oct. 14, 2016 (DE) 10 2016 220 101.8

(51) Int. Cl. G01M 13/045; G01N 29/28; G01N 29/04

(52) U.S. Cl. CPC G01M 13/045; G01N 29/28; G01N 2291/0423; G01N 2291/2696; G01N 29/041

(57) ABSTRACT

An arrangement is provided including at least one sound transducer and at least one component. The component is configured to be moved relative to the sound transducer. A gap is provided between the component and the sound transducer, and the gap is filled or is configured to be filled with a liquid.

### CROSS REFERENCE TO RELATED APPLICATIONS

This application is a U.S. National Stage Application under 35 U.S.C. § 371 of International Application No. PCT/EP2017/073920 filed on Sep. 21, 2017, and claims benefit to German Patent Application No. DE 10 2016 220 101.8 filed on Oct. 14, 2016. The International Application was published in German on Apr. 19, 2018 as WO 2018/069017 A1 under PCT Article 21(2).

### FIELD

The invention relates to an arrangement having a sound transducer.

### BACKGROUND

In order to monitor the condition of a transmission (condition monitoring), sensors must be attached to rotating shafts. The measured data is usually transmitted wirelessly. This is not only prone to errors; it also represents a cost factor.

In ultrasonic technology, a liquid column in the form of a laminar jet of bubble-free liquid is used for non-contact, non-destructive material testing. Ultrasound is introduced into a material to be tested via the liquid column.

### SUMMARY

In an embodiment, the present invention provides an arrangement including at least one sound transducer and at least one component. The component is configured to be moved relative to the sound transducer. A gap is provided between the component and the sound transducer. The gap is filled or is configured to be filled with a liquid.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a shaft with a sound transducer mounted on an end face;

FIG. 2 illustrates a shaft with a sound transducer mounted on a long side; and

FIG. 3 illustrates a sound transducer with a layer system.

### DETAILED DESCRIPTION

Embodiments of the invention improve the transmission of sound between a moving component and a sound transducer.

According to an embodiment of the invention, an arrangement is provided that comprises at least one sound transducer and at least one component. The sound transducer is a sound sensor and/or emitter. In other words, the sound transducer is designed to imitate and/or detect sound. The sound is preferably ultrasound.

The component is movable relative to the sound transducer. In particular, the component can be rotatably mounted relative to the sound transducer. For example, the component is a shaft. The sound transducer is preferably mounted in a stationary manner.

A gap is provided between the component and the sound transducer. The term “gap” refers to any intermediate space between the component and the sound transducer. It is a space in which the component and the sound transducer are adjacent. Preferably, the expansion of the gap in a first spatial direction and in a second spatial direction is greater than the expansion of the gap in a third spatial direction. The expansion in the third spatial direction corresponds to a distance between the component and the sound transducer.

According to the invention, the gap is filled or can be filled with a liquid. The liquid is used to transmit sound between the component and the sound transducer.

In a preferred additional form, the arrangement has at least one conduit for conducting a liquid. This flows into the gap and is thus connected to the gap in a manner that conducts the liquid. The liquid can be introduced into the gap through the conduit. In doing so, pressure is applied to the liquid.

It is not necessary to seal the gap. It is sufficient if the gap is created in such a manner that sufficient counter-pressure is built up.

In an additionally preferred development, in order to apply the pressure to the liquid, at least one means of applying the pressure to the liquid is provided. The means is a lubricant pump, for example. The gap is connected with such means in a manner that conducts the liquid. In particular, the gap can be connected to the means through the conduit described above in a manner that conducts the liquid.

A bearing gap of a hydrostatic plain bearing, which is connected to the means in a manner that conducts the liquid, is preferably identical to the gap specified above. In a preferred further development, instead of the hydrostatic plain bearing, a hydrodynamic plain bearing that forms the gap can also be used.

The component is rotatably mounted by means of the plain bearing, i.e. the component is fixed in a first bearing shell of the plain bearing. The first bearing shell forms a bearing gap, which is filled with a lubricant, with a second bearing shell. The sound transducer is integrated into the second bearing shell in such a manner that the lubricant acoustically couples the first bearing shell and the sound transducer. As a result, the component and the sound transducer are also acoustically coupled via the first bearing shell.

In a preferred development, the liquid is a lubricant. It can be the lubricant of the hydrodynamic or hydrostatic plain bearing or the lubricant that is conveyed via a conduit system to the lubrication points of a transmission. The conduit described above, which is connected to the gap in a manner that conducts the liquid, is part of this conduit system. This has the advantage that components that are already present in a transmission can be used.

The arrangement is suitable for use in the field of acoustic telemetry. In a preferred development, the sound transducer is accordingly designed to convert acoustic data. The data are comprised of formalized representations of information that can be interpreted according to ISO/IEC 2383-1. In particular, the information can be interpreted by machine. With the present invention, the data are encoded in an acoustic signal to be transmitted via the gap. The sound transducer preferably converts this signal into an electrical signal and/or generates it from the electrical signal. In the electrical signal, the same data are encoded as in the acoustic signal.

The physical properties of the component can be determined acoustically. For this purpose, the arrangement in a preferred development includes at least one evaluation unit. This is designed to process an output signal provided by the sound transducer. According to a development, the sound transducer is designed as a sound detector and converts sound, which is transmitted from the component via the gap, into the output signal. Depending on at least one physical property of the component, the sound changes and the output signal consequently changes. This enables the evaluation unit to determine the physical property on the basis of the output signal.

In order to introduce the sound into the component, an additional sound transducer in accordance with the invention is preferably provided. This is designed as a sound generator; that is, it converts a preferably electrical signal into sound. The sound is introduced into the component via the gap.

This coupling is preferably carried out using the Snell law of refraction. Here a coupling angle is selected at which part of the wave energy is totally reflected at the transition from the acoustically thinner medium to the acoustically thicker medium. The differential component then forms a surface wave in the acoustically denser medium. This occurs with the aim of converting compression waves in the liquid into surface shear waves (Rayleigh waves), which run along the surface of the component. The indifference of several such waves produces a signal that allows conclusions to be drawn regarding the mechanical load on the component. In particular, a deformation of the component can be inferred from which, in turn, a torque with which the component is loaded can be determined.

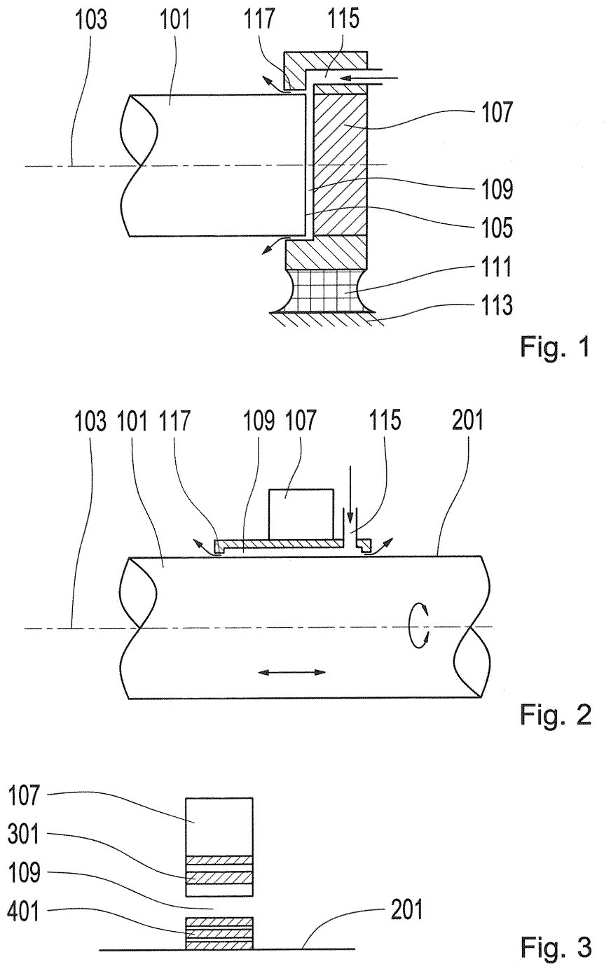

A shaft 101 shown in FIG. 1 is rotatably mounted around an axis of rotation 103. A end face 105 of the shaft 101, together with a sound transducer 107 arranged on the end face, forms a gap 109.

The sound transducer 107 is fixed in a stationary structure 113 by means of an elastomer 111. The elastomer 111 is used for the acoustic decoupling of the sound transducer 107 and the stationary structure 113.

A stationary lubricant conduit 115 flows into the gap 109. The lubricant conduit 115 is thus connected to the gap 109 in a manner that conducts lubricant. Lubricant, to which pressure is applied, flows through the lubricant conduit 115. As a result, the lubricant enters the gap 109.

The gap 109 is sealed against the shaft 101 by means of a labyrinth seal 117. The labyrinth seal 117 creates a counter-pressure acting on the inflowing liquid, which causes the gap 109 to fill completely with the liquid. The liquid acoustically couples the shaft and the sound transducer 107.

FIG. 2 shows a similar arrangement, in which the sound transducer 107 is not arranged on the end face, but on the circumference of the shaft 101. Here the gap 109 runs between a shell surface 201 of the shaft 101 and the sound transducer 107. This enables not only a rotation of the shaft 101, but also an axial displacement.

Different layers 301 shown in FIG. 3 can be arranged on both sides of the gap, in order to adjust the acoustic impedance of the transmission path.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

101 Shaft
103 Axis of rotation
105 End face
107 Sound transducer
109 Gap
111 Elastomer
113 Stationary structure
115 Conduit
117 Labyrinth seal
201 Shell surface
301 Layers

1. An arrangement comprising:
at least one sound transducer; and
at least one component,
wherein the component is configured to be moved relative to the sound transducer, and
wherein a gap is provided between the component and the sound transducer, and
wherein the gap is filled or is configured to be filled with a liquid.

2. The arrangement according to claim 1, further comprising at least one conduit, wherein the conduit is connected to the gap in a manner that conducts the liquid.

3. The arrangement according to claim 1, further comprising at least one pressure applicator configured to apply pressure to the liquid, wherein the gap is connected to the pressure applicator in a manner that conducts the liquid.

4. The arrangement according to claim 1, further comprising at least one hydrodynamic plain bearing, wherein the component is rotatably mounted by the hydrodynamic plain bearing, and wherein the sound transducer is at least partially integrated into a bearing shell of the plain bearing.

5. The arrangement according to claim 1; wherein the liquid is a lubricant.

6. The arrangement according to claim 1; wherein the sound transducer is configured to convert acoustic data.

7. The arrangement according to claim 1, further comprising at least one evaluation unit, wherein the sound transducer is designed to convert sound into an output signal, and wherein the evaluation unit is configured to determine at least one physical property of the component based on the output signal.
